(19) United States
(12) Patent Application Publication
(10) Pub. No.: US 2010/0318905 A1
(43) Pub. Date: Dec. 16, 2010

(54) Method for displaying menu screen in electronic devicing having touch screen

(75) Inventor: Gohel Rakesh, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/802,905

(22) Filed: Jun. 16, 2010

(30) Foreign Application Priority Data
Jun. 16, 2009 (KR) 10-2009-0053324

(51) Int. Cl. G06F 3/048; G06F 3/01

(52) U.S. Cl. 715/702; 715/830

(57) ABSTRACT

An electronic device is configured to display a menu screen. Then electronic device is capable of displaying the menu screen composed of a plurality of main menu items each of which has a plurality of subordinate menu items. The method further includes modifying the displayed menu screen by moving the subordinate menu items in response to a first drag input in a first direction or by moving the main menu items in response to a second drag input in a second direction. The method allows a user to perform a search for two or more subordinate menu items of different groups at a time on a single screen. Therefore, the number of times being key-pressed for a menu search is decreased, and the time required for a menu search is reduced.

### CROSS-REFERENCE TO RELATED APPLICATION(S) AND CLAIM OF PRIORITY

The present application is related to and claims priority to and the benefit of Korean Patent Application No. 10-2009-0053324 filed in the Korean Intellectual Property Office on Jun. 16, 2009, the entire contents of which are incorporated herein by reference

### TECHNICAL FIELD OF THE INVENTION

The present invention relates to a method for displaying a menu screen in an electronic device having a touch screen.

### BACKGROUND OF THE INVENTION

With modern scientific technique advanced dramatically, a great variety of mobile devices have been developed and introduced in the art. Rapid advances in mobile communication technologies are investing traditional mobile devices with many useful applications such as various kinds of data transmission services and additional personalized services that meet customer's demands.

Accordingly, as such mobile devices come to evolve into multimedia communication devices, the importance of a graphic user interface (GUI) for searching, selecting and executing menu items in a mobile device is growing more and more.

Normally this GUI has a hierarchical structure in which groups of menu items are arranged in different level depths. Therefore, a user should find a desired menu item from the uppermost level to any lower level, gradually increasing the depth of level. For instance, a user who wishes to use a function, such as taking a picture, may first select the ‘Additional Functions’ among menu items on the main menu screen with the uppermost level. Then the user may select the ‘Camera’ when subordinate menu items of the ‘Additional Functions’ are displayed in the next level depth, and select the ‘Take Pictures’ when subordinate menu items of the ‘Camera’ are displayed in the next level down. Namely, a user searches step by step menu screens with different depths through the menu keys, the navigation keys, the OK key, and the like, and thereby a mobile device displays one by one a menu screen prearranged in each level depth.

However, the above-discussed hierarchical structure inherently fails to allow a search for two or more subordinate menu items of different groups at a time on the main menu screen since such menu items are distributed to different menu screens with lower level depths. For example, if a user wishes to find a menu item ‘Bell Sounds’ while finding another menu item ‘Take Pictures’ (by sequentially selecting upper level menu items ‘Additional Functions’ and ‘Camera’), he or she should return to the main menu screen (by passing through the first lower menu screen) and then perform again a search process (by selecting a menu item ‘Sound’). Therefore, a user should press some keys several times to return to the main menu screen and then to go again into any level depth. Unfortunately, this may often incur a burden of search time and hence cause inconvenience to a user.

If the main menu screen allows a search for two or more subordinate menu items of different groups at a time, there will be no need to change menu screens according to their depths. Additionally, the number of times being key-pressed for a menu search will be decreased, and therefore the time required for a menu search will be reduced.

### SUMMARY OF THE INVENTION

To address the above-discussed deficiencies of the prior art, it is a primary object to provide at least the advantages described below.

An aspect of the present invention is to provide a method for displaying a menu screen which allows a simultaneous search for a plurality of subordinate menu items.

According to one aspect of the present invention, provided is a method for displaying a menu screen in an electronic device having a touch screen, the method comprising: displaying the menu screen composed of a plurality of main menu items each of which has a plurality of subordinate menu items; and modifying the displayed menu screen by moving the subordinate menu items in response to a first drag input in a first direction or by moving the main menu items in response to a second drag input in a second direction.

According to another aspect of the present invention, provided is an electronic device comprising: a touch sensor unit configured to detect at least one of a touch input and a drag input; a display unit configured to display a menu screen composed of a plurality of main menu items each of which has a plurality of subordinate menu items; and a control unit configured to receive the drag input in a first or second direction and to modify the displayed menu screen by moving the subordinate menu items in response to the drag input in the first direction or by moving the main menu items in response to the drag input in the second direction.

Aspects of this invention allow a user to perform a search for two or more subordinate menu items of different groups at a time on a single screen. Therefore, the number of times being key-pressed for a menu search is decreased, and the time required for a menu search is reduced.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates the configuration of a mobile device in accordance with an exemplary embodiment of the present invention.

FIGS. 2A to 2C illustrate a menu screen of a mobile device in accordance with exemplary embodiments of the present invention.

FIG. 3 illustrates a process for displaying a menu screen of a mobile device in accordance with an exemplary embodiment of the present invention.

FIG. 4 illustrates a detailed process of the menu screen setting step in FIG. 3 in accordance with an exemplary embodiment of the present invention.

FIG. 5 illustrates another process of the menu screen setting step in FIG. 3 in accordance with another exemplary embodiment of the present invention.

FIG. 6 illustrates a menu list used in the menu screen setting step in accordance with an exemplary embodiment of the present invention.

FIGS. 7A and 7B illustrate a menu screen changed by an upward drag input in accordance with exemplary embodiments of the present invention.

FIGS. 8A and 8B illustrate a menu screen changed by a leftward drag input in accordance with exemplary embodiments of the present invention.

### DETAILED DESCRIPTION OF THE INVENTION

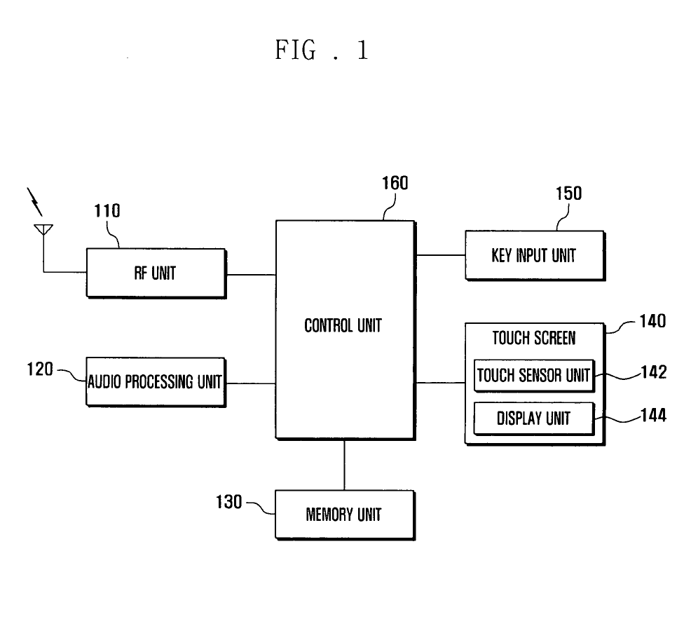

FIGS. 1 through 8B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable device. Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

Although a mobile device will be employed for descriptions in the following embodiments, this is exemplary only and not to be considered as a limitation of the present invention. In addition to a mobile device, a great variety of electronic devices such as TV, a computer, a notebook, and any other kinds of display devices may also be used for this invention. Meanwhile, a mobile device applied to embodiments of this invention may include a mobile phone, a portable multimedia player (PMP), a personal digital assistant (PDA), a smart phone, a music player (such as an MP3 player), a digital broadcasting player, a car navigation system, and any other kinds of portable or handheld terminals having a touch-sensitive interface.

FIG. 1 illustrates a configuration of a mobile device in accordance with an exemplary embodiment of the present invention.

Referring to FIG. 1, the mobile device includes a radio frequency (RF) unit 110, an audio processing unit 120, a memory unit 130, a touch screen 140, a key input unit 150, and a control unit 160. In particular, the touch screen 140 includes a touch sensor unit 142 and a display unit 144.

The RF unit 110 performs data transmission and reception for a wireless communication of the mobile device. The RF unit 110 may include an RF transmitter that upwardly converts the frequency of signals to be transmitted and amplifies the signals, and an RF receiver that amplifies received signals with low-noise and downwardly converts the frequency of the received signals. Additionally, the RF unit 110 receives data through a wireless channel and sends it to the control unit 160. Also, the RF unit 110 receives data from the control unit 160 and transmits it through a wireless channel.

The audio processing unit 120 may include a codec that may be composed of a data codec for processing packet data and an audio codec for processing audio signals. The audio processing unit 120 converts digital audio signals into analog audio signals through the audio codec and then outputs them through a speaker (SPK) (not shown). Also, the audio processing unit 120 converts analog audio signals inputted from a microphone (MIC) (not shown) into digital audio signals through the audio codec.

The memory unit 130 stores a variety of programs and data required for the operation of the mobile device. The memory unit 130 may be divided into a program region and a data region. In embodiments of this invention, the memory unit 130 stores menu screen setting information. Specifically, the memory unit 130 stores image information and font information about main menu items and subordinate menu items which form together a menu screen. Furthermore, the memory unit 130 stores information about the arrangement of the main menu items and subordinate menu items and information about the moving range of the main menu item or subordinate menu item in response to a single drag action. Particularly, the memory unit 130 may store information about the main menu items and subordinate menu items selected by a user in a menu screen setting step.

The touch screen 140 includes the touch sensor unit 142 and the display unit 144. The touch sensor unit 142 detects any contact with the surface by a certain object such as a user's finger or a touch pen (or stylus pen). In some embodiments, the touch sensor unit 142 can include well known touch-sensitive sensors of capacitive overlay type, resistive overlay type, infrared beam type or the like, or alternatively may be formed of pressure sensors. These sensors are, however, exemplary only and need not be considered as a limitation of the present invention. Any other kinds of sensors capable of detecting the contact or pressure of an object may also be used for the touch sensor unit 142. In some embodiments, the touch sensor unit 142 is disposed on the front of the display unit 144. The touch sensor unit 142 detects a user's touch action, creates a touch input signal, and transmits it to the control unit 160. The touch input signal may contain information about the location of a touch occurrence.

The display unit 144 can be formed of a liquid crystal display (LCD) or any other equivalents. The display unit 144 represents, in a visual manner, a variety of information such as menu items, input data, setting data, and any other graphical elements. For example, the display unit 144 outputs various screens such as a booting screen, an idle screen, a menu screen, a call screen, and any other application execution screens. In some embodiments of this invention, the display unit 144 displays a menu screen stored in the memory unit 130 under the control of the control unit 160. Additionally, the display unit 144 displays main menu items and subordinate menu items of the menu screen changed under the control of the control unit 160.

The key input unit 150 receives a user's key press action for controlling the mobile device, creates a key input signal, and transmits it to the control unit 160. The key input unit 150 can be formed of a keypad having alphanumeric keys and navigation keys, and may also include some special function keys disposed for example on the lateral sides of the mobile device. In embodiments of this invention, the key input unit 150 may be omitted when the mobile device allows the manipulation with the touch sensor unit 142 only.

The control unit 160 controls the whole operations of the mobile device. In embodiments of this invention, the control unit 160 sets up a menu screen depending on a user's input. Specifically, the control unit 160 sets up the menu screen, depending upon main menu items and subordinate menu items selected by a user in a menu screen setting step. Also, the control unit 160 sets up the menu screen, depending upon information about the arrangement of the main menu items and subordinate menu items and information about the moving range of the main menu item or subordinate menu item in response to a single drag action. Then the control unit 160 causes the memory unit 130 to store the menu screen setting information.

Additionally, the control unit 160 determines whether instructions to display a menu screen is inputted through the touch sensor unit 142 or the key input unit 150, retrieves a predefined menu screen from the memory unit 130, and controls the display unit 144 to display the retrieved menu screen. Also, the control unit 160 determines whether a touch and drag is inputted on a specific one of the main menu items and subordinate menu items, and whether the direction of a drag coincides with the arrangement of the main menu items or subordinate menu items, by controlling the touch sensor unit 142. Then the control unit 160 causes the display unit 144 to display the main menu items and subordinate menu items moved in response to a drag. Here, the control unit 160 uses the moving range of the main menu item or subordinate menu item predefined with regard to a single drag action.

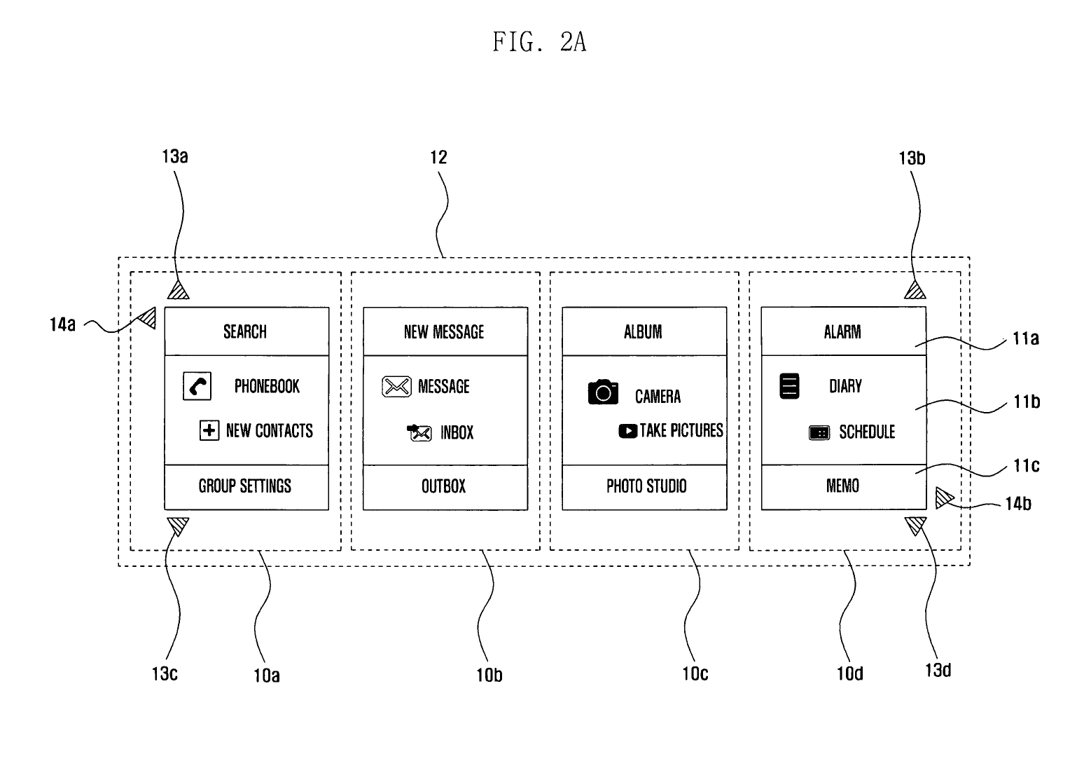

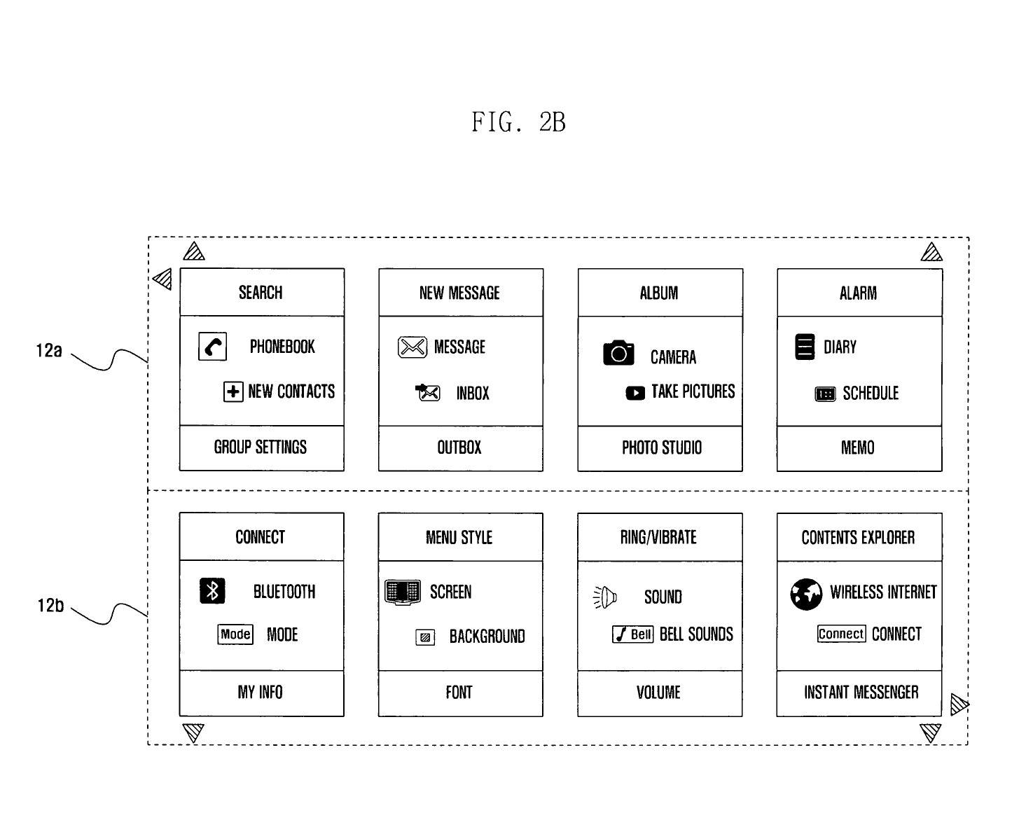

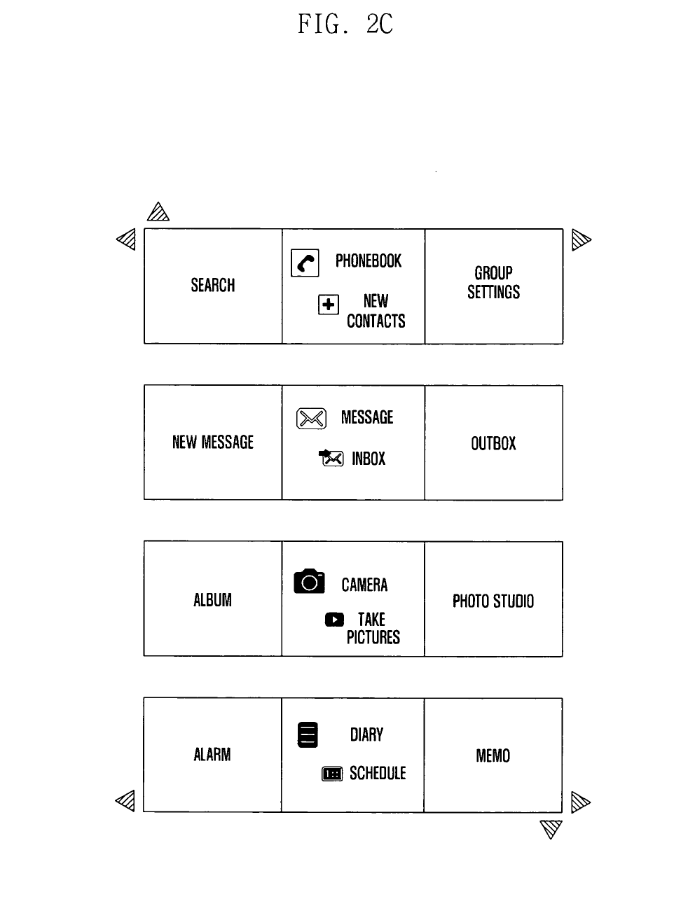

FIGS. 2A to 2C illustrate a menu screen of a mobile device in accordance with exemplary embodiments of the present invention. In embodiments of this invention, a menu screen refers to a particular page in which menu items of the mobile device are arranged and displayed in a given GUI form. Preferably, such a menu screen corresponds to a main menu screen with the uppermost level depth.

A menu screen shown in FIG. 2A is composed of main menu items 10a to 10d, vertical move indicators 13a to 13d, and horizontal move indicators 14a and 14b. Each of the main menu items 10a to 10d has subordinate menu items 11a to 11c, and all the main menu items 10a to 10d form together a main menu item block 12.

The main menu items 10a to 10d are one kind of menu objects forming a menu screen. Each of the main menu items 10a to 10d contains at least one subordinate menu item. The lowest menu item with no subordinate menu item cannot be used as the main menu item. In FIG. 2A, ‘Phonebook’, ‘Message’, ‘Camera’, and ‘Diary’ represent example names of the main menu items 10a to 10d.

The ordinate menu items 11a to 11c are another kind of menu objects forming a menu screen. A certain number of subordinate menu items 11a to 11c form a single main menu item. Different groups of subordinate menu items with a lower level depth belong to different main menu items with an upper level depth. The uppermost menu item cannot be used as the subordinate menu item. In FIG. 2A, ‘Alarm’, ‘Schedule’, and ‘Memo’ ‘represent example names of the subordinate menu items 11a to 11c belonging to the main menu item ‘Diary’. These subordinate menu items ('Alarm’, ‘Schedule’, and ‘Memo’) may be the most frequently used items among the subordinate menu items belonging to the main menu item ‘Diary’. The rest of the subordinate menu items will appear in response to instructions to move the subordinate menu items. Meanwhile, a name of each main menu item (e.g., ‘Diary’) may be displayed on the most frequently used subordinate menu item (e.g., ‘Schedule’). Although FIG. 2A shows three subordinate menu items displayed in each main menu item, the present invention is not limited to this example. Alternatively, subordinate menu items more than or less than three items may be displayed in each main menu item.

As mentioned above, the main menu items 10a to 10d may form together the main menu item block 12. In embodiments of this invention, the main menu item block 12 may be defined as the moving range of the main menu items 10a to 10d in response to a user's drag input. In FIG. 2A, four main menu items ‘Phonebook’, ‘Message’, ‘Camera’, and ‘Diary’ constitute a single main menu item block 12.

The vertical move indicators 13a to 13d are graphical symbols indicating that the subordinate menu items can be moved and newly displayed when there is a drag input in up and down directions. For example, if an upward move indicator 13a or 13b is displayed, the subordinate menu items 11a to 11c can be moved upward in response to a user's upward drag input on the main menu item 10d. According to some embodiments of this invention, the moving range of the subordinate menu items may be defined as a distance corresponding to one subordinate menu item or three subordinate menu items. If there is no upward move indicator displayed, the subordinate menu items remain unmoved even though a user's upward drag input occurs. In some embodiments of this invention, the upward move indicator 13a or 13b may be displayed on only a specific main menu item touched by a user.

The horizontal move indicators 14a and 14b are graphical symbols indicating that the main menu items can be moved and newly displayed when there is a drag input in left and right directions. For example, if a rightward move indicator 14b is displayed, the main menu items 10a to 10d can be moved rightward in response to a user's rightward drag input on any main menu item. According to some embodiments of this invention, the moving range of the main menu items may be defined as a distance corresponding to one main menu item or more. In another embodiment, the main menu item block 12 may be used as the moving range of the main menu items. If there is no rightward move indicator displayed, the main menu items remain unmoved even though a user's rightward drag input occurs.

Another menu screen shown in FIG. 2B is composed of two main menu item blocks 12a and 12b. As compared with FIG. 2A, the number of the main menu items forming the menu screen is doubled. Hence the moving range of the main menu items may be reduced.

Still another menu screen shown in FIG. 2C includes a different arrangement of the main menu items and subordinate menu items in comparison with the aforesaid menu screens. Namely, the menu screens shown in FIGS. 2A and 2B include horizontally arranged main menu items and vertically arranged subordinate menu items, whereas the menu screen shown in FIG. 2C includes horizontally arranged subordinate menu items and vertically arranged main menu items. Therefore, a user can move the subordinate menu items through a drag input in up and down directions and move the main menu items through a drag input in left and right directions.

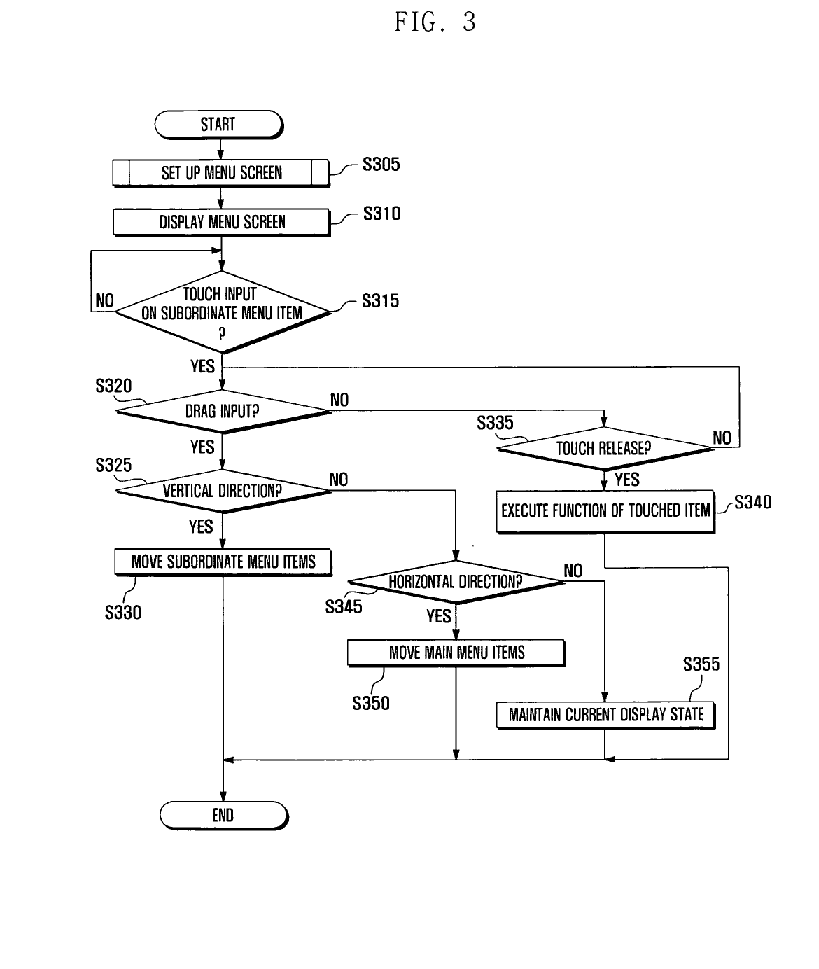

FIG. 3 illustrates a method for displaying a menu screen of a mobile device in accordance with an exemplary embodiment of the present invention.

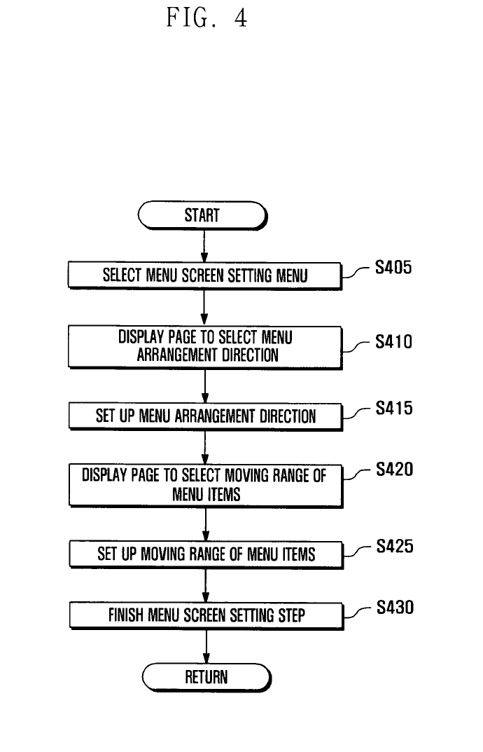

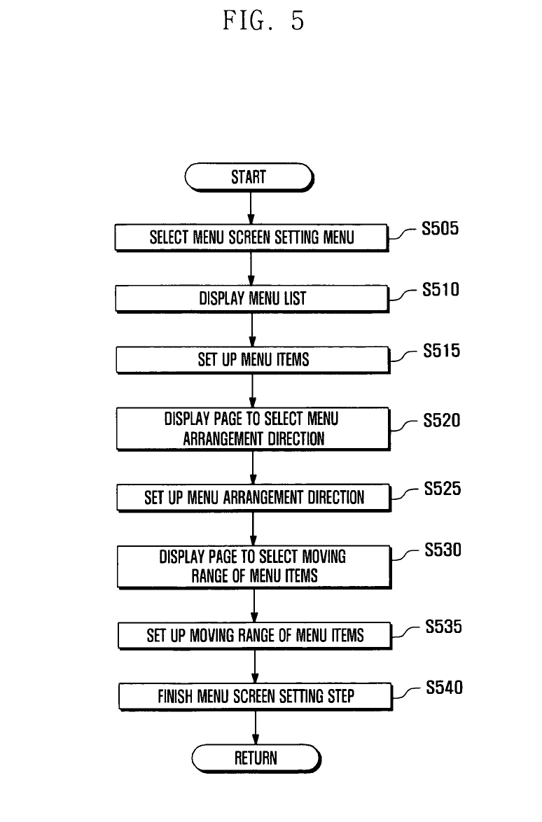

Referring to FIG. 3, at the outset, the control unit 160 sets up a menu screen (step S305). In embodiments of this invention, such a menu screen may correspond to a main menu screen with the uppermost level depth. A detailed process of this step S305 is shown in FIGS. 4 and 5, which will be described below.

After setting up the menu screen, the control unit 160 controls the display unit 144 to display the menu screen (step S310). The above-discussed menu screens shown in FIGS. 2A to 2C are examples of the menu screen displayed in this step S310. The following description will use the menu screen shown in FIG. 2A. In another embodiment, the control unit 160 may control the display unit 144 to display on the menu screen the main menu items 10a to 10d only without displaying the vertical move indicators 13a to 13d and the horizontal move indicators 14a and 14b. In step S310, under the control of the control unit 160, each main menu item displayed is composed of a group of selected subordinate menu items.

Then, by controlling the touch sensor unit 142, the control unit 160 determines whether a user's touch input occurs (step S315). If a user touches any point on the touch screen 140, the touch sensor unit 142 creates a touch input signal and transmits it to the control unit 160. This touch input signal contains information about the location of a touch occurrence. When receiving the touch input signal from the touch sensor unit 142, the control unit 160 determines whether a touch input occurs on any subordinate menu item. If yes, the control unit 160 recognizes a touched one of the subordinate menu items.

After the touched subordinate menu item is recognized, the control unit 160 controls the display unit 144 to display the vertical move indicators and the horizontal move indicators. More particularly, under the control of the control unit 160, the vertical move indicators may be displayed on the upper and lower sides of a specific main menu item which contains the touched subordinate menu item, and the horizontal move indicators may be displayed on the left and right sides. In an alternative embodiment, the vertical move indicators displayed may be respectively located on the upper and lower sides of both the leftmost and rightmost main menu items 10a and 10d in the main menu item block 12, and the horizontal move indicators displayed may be located displayed on both the left side of the leftmost main menu item 10a and the right side of the rightmost main menu item 10d.

In some embodiment, the control unit 160 may give a highlight to the touched subordinate menu item, a specific main menu item having the touched item, and a specific main menu item block having the touched item. For instance, emphasized edges or different colors may be used for a highlight effect.

If there is a user's touch input, the control unit 160 further determines whether a user's drag action is inputted from the touch sensor unit 142 (step S320). A drag refers to the movement of a touched point on the touch screen 140 and may also include a stay and a release after a movement. When a user's drag action occurs on the touch screen 140, the touch sensor unit 142 creates a drag input signal and transmits it to the control unit 160. This drag input signal contains information about the location of a touch movement.

If there is a user's drag input, the control unit 160 receives a drag input signal and then determines the direction of a drag by using information about the location of a touch movement. More particularly, the control unit 160 determines whether a drag travels in a vertical direction (step S325). If the subordinate menu items are arranged in a vertical direction, the control unit 160 receiving a vertical drag input controls the display unit 144 to display the subordinate menu items vertically moved in response to a vertical drag input (step S330). When an upward drag is inputted, the control unit 160 controls the display unit 144 to display the subordinate menu items moved upward. Similarly, when a downward drag is inputted, the control unit 160 controls the display unit 144 to display the subordinate menu items moved downward. Here, the control unit 160 may move the subordinate menu items by the distance corresponding to one or more subordinate menu items.

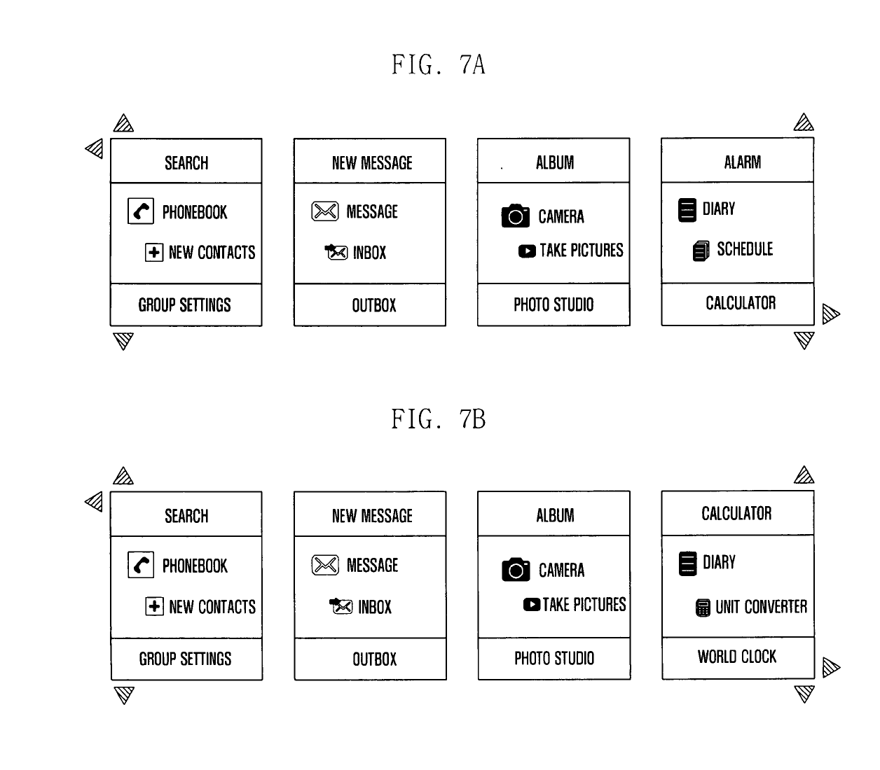

FIGS. 7A and 7B illustrate a menu screen changed by an upward drag input in accordance with exemplary embodiments of the present invention. Specifically, FIG. 7A shows a case in which the subordinate menu items in a selected main menu item are moved upward by the distance corresponding to a single subordinate menu item. For example, if an upward drag is inputted on the rightmost main menu item 10d shown in FIG. 2A, the first subordinate menu item ‘Alarm’ moves upward and disappears from the menu screen on the display unit 144. In addition, the second subordinate menu item ‘Schedule’ moves upward and occupies the former place of ‘Alarm’, and the third subordinate menu item ‘Memo’ moves upward and occupies the former place of ‘Schedule’. Also, a new subordinate menu item ‘Calculator’ appears on the former place of ‘Memo’. Alternatively, FIG. 7B shows a case in which the subordinate menu items in a selected main menu item are moved upward by the distance corresponding to three subordinate menu items. More particularly, three subordinate menu items shown in FIG. 2A are replaced at a time with new ones ('Calculator', ‘Unit Converter’, ‘World Clock’) in response to an upward drag input.

In some embodiment of this invention, the control unit 160 may determine whether any of the subordinate menu items currently displayed has the highest priority or the lowest priority. If a subordinate menu item with the highest priority is displayed, the control unit 160 may force all the displayed subordinate menu items to remain unmoved even though an upward drag is inputted. Additionally, if a subordinate menu item with the lowest priority is displayed, the control unit 160 may force all the displayed subordinate menu items to remain unmoved even though a downward drag is inputted. When an upward movement of the subordinate menu items is not allowed, the control unit 160 may remove the upward move indicator 13a or 13b from the menu screen. Similarly, when a downward movement of the subordinate menu items is not allowed, the control unit 160 may remove the downward move indicator 13c or 13d from the menu screen.

Returning to FIG. 3, if in the aforesaid step S325 it is determined that a drag does not travel in a vertical direction, the control unit 160 further determines whether a drag travels in a horizontal direction (step S345). If the main menu items are arranged in a horizontal direction, the control unit 160 receiving a horizontal drag input controls the display unit 144 to display the main menu items horizontally moved in response to a horizontal drag input (step S350). When a leftward drag is inputted, the control unit 160 controls the display unit 144 to display the main menu items moved leftward. Similarly, when a rightward drag is inputted, the control unit 160 controls the display unit 144 to display the main menu items moved rightward. Here, the control unit 160 may move the main menu items by the distance corresponding to one or more main menu items. Also, the control unit 160 may use the main menu item block as the moving range of the main menu items.

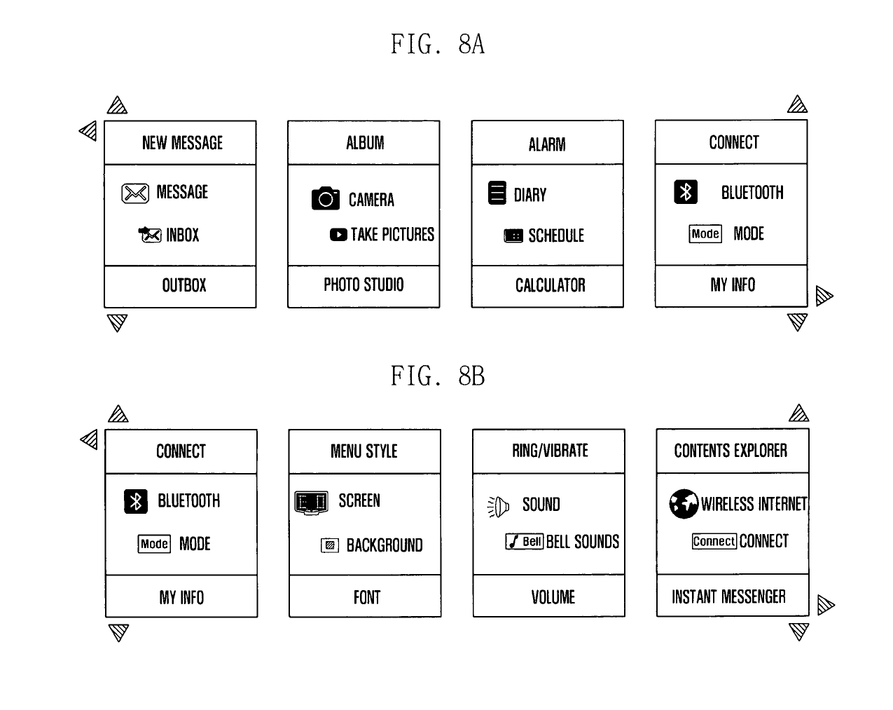

FIGS. 8A and 8B illustrate a menu screen changed by a leftward drag input in accordance with exemplary embodiments of the present invention. Specifically, FIG. 8A shows a case in which the main menu items on the menu screen are moved leftward by the distance corresponding to a single main menu item. For example, if a leftward drag is inputted on the menu screen shown in FIG. 2A, the first main menu item ‘Phonebook’ moves leftward and disappears from the menu screen on the display unit 144. In addition, the second main menu item ‘Message’ moves leftward and occupies the former place of ‘Phonebook’, the third main menu item ‘Camera’ moves leftward and occupies the former place of ‘Message’, and the fourth main menu item ‘Diary’ moves leftward and occupies the former place of ‘Camera’. Also, a new main menu item ‘Bluetooth’ appears on the former place of ‘Diary’. Alternatively, FIG. 8B shows a case in which the main menu items on the menu screen are moved leftward by the distance corresponding to four main menu items. More particularly, four main menu items shown in FIG. 2A are replaced at a time with new ones (‘Bluetooth’, ‘Screen’, ‘Sound’, ‘Wireless Internet’) in response to a leftward drag input.

Returning to FIG. 3, if in the aforesaid step S345 it is determined that a drag does not travel in a horizontal direction, the control unit 160 controls the display unit 144 to maintain a current display state (step S355). In some embodiments of this invention, the margin of a vertical or horizontal drag may be predefined in the mobile device. In this example, when a user's drag action is inputted, the control unit 160 determines whether an inputted drag is a vertical drag or a horizontal drag or neither of them, depending on whether the direction of a drag is within the predefined margin of a vertical or horizontal drag.

Meanwhile, if in the aforesaid step S320 it is determined that no drag action is inputted, the control unit 160 further determines whether a touch is released (step S335). If a touch is released without a drag input, the control unit 160 executes a particular function assigned to the touched subordinate menu item (step S340). In some embodiment of this invention, if the touched subordinate menu item has any further subordinate menu item, the control unit 160 controls the display unit 144 to display such a further subordinate menu item. Here, the control unit 160 may change entirely the menu screen into a new one to display a further subordinate menu item or may modify the menu screen to additionally display a further subordinate menu item.

As discussed hereinbefore, a menu screen according to this invention includes a plurality of main menu items, each of which has a plurality of subordinate menu items. Since the main menu items and the subordinate menu items are arranged in different directions, a user can selectively perform a search for main menu items or subordinate menu items through a drag action in the direction of the arrangement of the main menu items or the subordinate menu items.

FIG. 4 illustrates a detailed process of the menu screen setting step in FIG. 3 in accordance with an exemplary embodiment of the present invention. Namely, FIG. 4 shows a possible detailed process of the aforesaid step S305 in FIG. 3.

Referring to FIG. 4, at the outset, the control unit 160 receives a user's selection of a menu screen setting menu through the touch sensor unit 142 or the key input unit 150 (step S405). Then the control unit 160 controls the display unit 144 to display a page requiring a user's selection of a menu arrangement direction (step S410). This page may consist of only the option to select the arrangement direction of main menu items. Alternatively, this page may consist of the first option to select the arrangement direction of main menu items and the second option to select the arrangement direction of subordinate menu items. Among all menu items provided for the mobile device, any menu items including the uppermost level or middle levels except the lowest level may be used for the main menu items. Also, any menu items belonging to the main menu item may be used for the subordinate menu items. In some embodiment of this invention, the control unit 160 may calculate the frequency used of main menu items and/or subordinate menu items, and then control the display unit 144 to display them in descending order of the frequency used.

When a user chooses a desired one of possible directions of menu arrangement, the control unit 160 sets up the menu arrangement direction according to a user's input (step S415). For instance, if a user chooses the horizontal direction as the arrangement direction of main menu items, the control unit 160 fixes the horizontal direction as the arrangement direction of main menu items and also the vertical direction as the arrangement direction of subordinate menu items.

Next, the control unit 160 controls the display unit 144 to display a page requiring a user's selection of a moving range of menu items per drag input (step S420). This page may include separate options to select a moving range of main menu items and to select a moving range of subordinate menu items. The moving range of the main menu items per drag input may be varied from a distance corresponding to one main menu item to a distance corresponding to displayed all main menu items. Similarly, the moving range of the subordinate menu items per drag input may be varied from a distance corresponding to one subordinate menu item to a distance corresponding to displayed all subordinate menu items.

When a user chooses a desired one of possible moving ranges of menu items, the control unit 160 sets up the moving range of menu items according to a user's input (step S425). Then the control unit 160 finishes the process of the menu screen setting step when there is a user's input (step S430).

FIG. 5 illustrates an alternative detailed process of the menu screen setting step in FIG. 3 in accordance with another exemplary embodiment of the present invention. More particularly, FIG. 5 shows another possible detailed process of the aforesaid step S305 in FIG. 3.

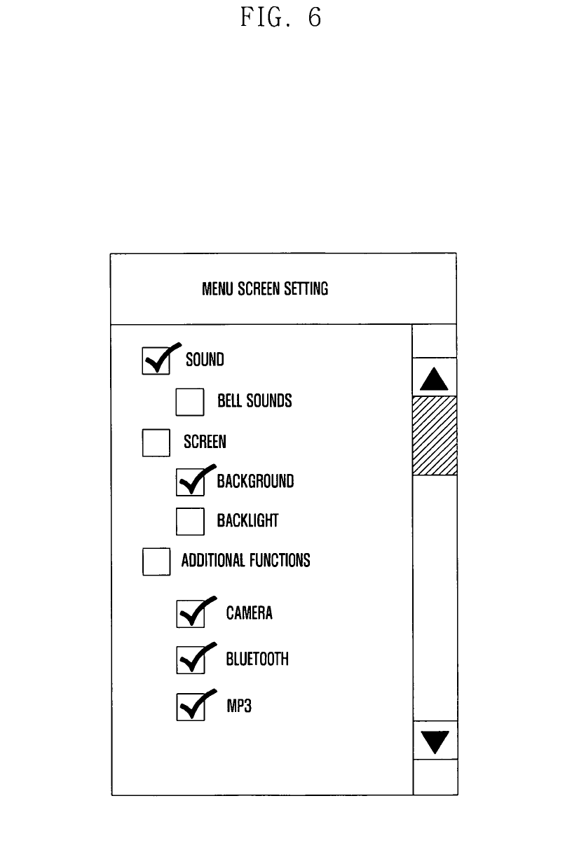

Referring to FIG. 5, at the outset, the control unit 160 receives a user's selection of a menu screen setting menu through the touch sensor unit 142 or the key input unit 150 (step S505). Then the control unit 160 controls the display unit 144 to display a menu list stored in the memory unit 130 (step S510). This menu list is composed of main menu items with the uppermost level and subordinate menu items with the next level. FIG. 6 is an example view illustrating such a menu list used in the menu screen setting step in accordance with an exemplary embodiment of the present invention. In a menu list shown in FIG. 6, three items ‘Sound’, ‘Screen’ and ‘Additional Functions’ are main menu items with the uppermost level, whereas the others ‘Bell Sounds’, ‘Background’, ‘Backlight’, ‘Camera’, ‘Bluetooth’ and ‘MP3’ are subordinate menu items with the next level.

Returning to FIG. 5, when a user chooses at least one menu item in a displayed menu list, the control unit 160 receives a user's selection of menu items through the touch sensor unit 142 or the key input unit 150 and then sets up the main menu items and subordinate items according to a user's input (step S515). Next, the control unit 160 performs steps S520 to S540 which are equal to the above-discussed steps S410 to S430 in FIG. 4, respectively. For reasons of similarity, the repetition of the same description will be avoided herein.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for displaying a menu screen in an electronic device having a touch screen, the method comprising:
displaying the menu screen composed of a plurality of main menu items each of which has a plurality of subordinate menu items; and
modifying the displayed menu screen by moving the subordinate menu items in response to a first drag input in a first direction or by moving the main menu items in response to a second drag input in a second direction.

2. The method of claim 1, wherein the displaying of the menu screen includes:
arranging the subordinate menu items in the first direction and;
arranging the main menu items in the second direction.

3. The method of claim 2, wherein the displaying of the menu screen further includes:
arranging two or more main menu item blocks in the first direction, each of the main menu item blocks having the main menu items arranged in the second direction.

4. The method of claim 1, wherein the modifying of the displayed menu screen includes:
removing at least one of the subordinate menu items from the displayed menu screen and instead offering at least one new subordinate menu item to the displayed menu screen when receiving the first drag input; and
removing at least one of the main menu items from the displayed menu screen and instead offering at least one new main menu item to the displayed menu screen when receiving the second drag input.

5. The method of claim 1, further comprising:
setting up the menu screen.

6. The method of claim 5, wherein the setting up of the menu screen includes:
displaying a menu list having a plurality of menu items stored in the electronic device;
receiving a user's selection of the menu items; and
setting up the main menu items and the subordinate menu items to be displayed on the menu screen, depending on the received user's selection.

7. The method of claim 6, wherein the setting up of the menu screen further includes:
setting up an arrangement direction of the main menu items.

8. The method of claim 6, wherein the setting up of the menu screen further includes:
setting up a moving range of the menu items per drag input.

9. The method of claim 8, wherein the modifying of the displayed menu screen includes:
moving the main menu items and/or the subordinate menu items, depending on the moving range.

10. The method of claim 1, wherein the displaying of the menu screen includes:
displaying the main menu items and/or the subordinate menu items in descending order of the frequency used.

11. The method of claim 1, wherein the displaying of the menu screen includes:
displaying a name of each main menu item on the most frequently used one of the subordinate menu items.

12. The method of claim 1, wherein the displaying of the menu screen includes:
displaying a given number of the subordinate menu items selected in descending order of the frequency used.

13. An electronic device comprising:
a touch sensor unit configured to detect at least one of a touch input and a drag input;
a display unit configured to display a menu screen composed of a plurality of main menu items each of which has a plurality of subordinate menu items; and
a control unit configured to receive the drag input in a first or second direction from the touch sensor and control the display unit to modify the displayed menu screen by moving the subordinate menu items in response to the drag input in the first direction or by moving the main menu items in response to the drag input in the second direction.

14. The electronic device of claim 13, wherein the control unit is further configured to control the display unit such that the subordinate menu items are arranged in the first direction and the main menu items are arranged in the second direction.

15. The electronic device of claim 13, wherein the control unit is configured to:
control the display unit to remove at least one of the subordinate menu items from the displayed menu screen and instead offering at least one new subordinate menu item to the displayed menu screen when receiving the first drag input from the touch sensor; and
control the display unit to remove at least one of the main menu items from the displayed menu screen and instead offering at least one new main menu item to the displayed menu screen when receiving the second drag input from the touch sensor.

16. The electronic device of claim 13, wherein the control unit further is configured to set up the menu screen.

17. The electronic device of claim 13, wherein the control unit is configured to:
control the display unit to display a menu list having a plurality of menu items stored in the electronic device; receive a user's selection of the menu items from the touch sensor;
set up the main menu items and the subordinate menu items and control the display unit to display the set up main menu items and subordinate menu itemson the menu screen, according to the received user's selection.

18. The electronic device of claim 17, wherein the control unit is configured to:
set up an arrangement direction of the main menu items.

19. The electronic device of claim 17, wherein the control unit is configured to:
set up a moving range of the menu items per drag input.

20. The electronic device of claim 19, wherein the control unit is configured to:
control the display unit to move the main menu items and/or the subordinate menu items, depending on the set up moving range.

21. The electronic device of claim 17, wherein the display unit is configured to display the main menu items and/or the subordinate menu items in descending order of the frequency used.
